(19) United States
(12) Patent Application Publication
(10) Pub. No.: US 2026/0187641 A1
(43) Pub. Date: Jul. 2, 2026

(54) MULTI-MODEL ANALYSIS OF TRANSACTIONS FOR MULTI-USER ACCOUNTS

(71) Applicant: Bank of America Corporation, Charlotte, NC (US)

(72) Inventors: Freddy Cabrera, Matthews, NC (US); Manu Kurian, Dallas, TX (US); Priyank Shah, Plano, TX (US)

(21) Appl. No.: 19/008,215

(22) Filed: Jan. 2, 2025

(51) Int. Cl. G06Q 20/40

(52) U.S. Cl. CPC G06Q 20/4016; G06Q 20/40145

(57) ABSTRACT

This disclosure relates to detecting fraudulent transactions in a multi-user account based on multimodal data that reflects the actions of multiple users of the account. A system and process may receive transaction requests associated with the multi-user account from multiple users at multiple user-interactive computers. A server receives the transaction requests from the user-interactive computers. The server may also receive multimodal data, such as audio, video, biometric, and other data that provides information about the actions of at least two of the users. The server analyzes the transaction requests and multimodal data to detect correlations between the user's actions and transaction requests that may be indicative of an unauthorized or fraudulent transaction.

### BACKGROUND

Detecting fraudulent or unauthorized access to organizational or transactional accounts (e.g., bank accounts, credit card accounts, website memberships, governmental accounts, etc.) is paramount to avoiding theft of sensitive information, goods, and money. In large organizations, user access to accounts is typically granted on an individual basis and generally approved through a process of authentication in which one or more users are verified as being authentic and authorized to access the account. Some accounts may have multiple users authorized to access an account, and each user may have different levels of privilege in accessing the account. The multi-user nature of such accounts increases the complexity of detecting fraud or unauthorized access because, for example, the number of locations the account can be simultaneously accessed from and the number of credentials to verify are increased.

### SUMMARY

The following summary is intended to provide a simplified understanding of some aspects of the disclosure. It is not a comprehensive overview, nor does it aim to identify key elements or delineate the scope of the disclosure. Instead, it serves as a brief introduction to the concepts discussed in the subsequent description.

Aspects of the disclosure provide effective, efficient, scalable, and convenient technical solutions that address and overcome the technical problems associated with detecting fraud and unauthorized access to multi-user accounts.

In accordance with some aspects, a system is provided to analyze transactions for multi-user accounts on a network. The system may include a plurality of user-interactive computers that are coupled to the network and that comprise first processors and first memory having data collection applications stored therein. The data collection applications executed by the first processor may cause the plurality of user-interactive computers to receive multiple transaction requests associated with a multi-user account, wherein the multiple transaction requests are associated with multiple users, respectively. The user-interactive computers may provide a user-interactive interface for the users to conduct the transactions.

The system may include at least one computer server coupled to the network and comprising at least one second processor and second memory with at least one data analysis application stored therein. The at least one data analysis application executed by the at least one second processor may cause the at least one computer server to receive the multiple transaction requests via the network from the plurality of user-interactive computers, and receive multimodal data indicative of physical action of each of at least two users of the multiple users, The at least one server may generate, using one or more artificial intelligence models and based on the physical action of each of the at least two users, a score indicating a likelihood that at least one of the multiple transaction requests is unauthorized, and based on the score, prevent at least one transaction associated with the multiple transaction requests.

The multimodal data may comprise audio, voice, image, or location data of at least two users. The multimodal data may comprise information associating the physical action of each of the at least two users with the multiple transaction requests received via the user-interactive interfaces.

In some aspects, the at least one data analysis application executed by the at least one second processor causes the at least one computer server to receive the multimodal data indicative of the physical action of each of the at least two users from the plurality of user-interactive computers, receive additional multimodal data unassociated with the multiple transaction requests, and determine, using the one or more artificial intelligence models, an association between the additional multimodal data and the multiple transaction requests. The score may be based on the association.

In some aspects, the at least one data analysis application of the at least one server may use the one or more artificial intelligence models to determine a correlation between each physical action of the at least two users, and the score may be based on the correlation. In some examples, the score may be based on the relative locations of the at least two users or the relative timing of at least two of the multiple transaction requests.

In some aspects, the one or more artificial intelligence models may use the multimodal data to detect a pattern for each of the at least two users, and determine an association between the patterns for the at least two users, wherein the score is based on the association. The detected patterns may include a mood pattern, a voice pattern, a word pattern, a transaction pattern, a movement pattern, or a location pattern.

In some aspects, the at least one data analysis application executed by the at least one second processor causes the at least one computer server to receive the multiple transaction requests and the multimodal data over a period of time, and update the score dynamically over the period of time as the multiple transaction requests and the multimodal data is received by the at least one computer server.

In some aspects, the one or more artificial intelligence models comprise a deep learning model, and the at least one data analysis application executed by the at least one second processor causes the at least one computer server to receive feedback on the accuracy of the score, and train the deep learning model based on the feedback.

These features, along with many others, are discussed in greater detail below.

### BRIEF DESCRIPTION OF THE DRAWINGS

The present disclosure is illustrated by way of example and not limited to the accompanying figures in which like reference numerals indicate similar elements and in which:

FIGS. 1A-1C depict an illustrative computing environment for implementing a system for analyzing transactions for multi-user accounts in accordance with one or more example embodiments;

FIG. 2 depicts an illustrative method for receiving transaction requests via user-interactive computers in accordance with one or more example embodiments;

FIGS. 3A-3D depict illustrative methods for detecting unauthorized transactions in a multi-user account in accordance with one or more example embodiments;

FIG. 4 depicts an illustrative method of training a deep learning model to identify unauthorized transactions in a multi-user account in accordance with one or more example embodiments;

FIG. 5 illustrates one example environment in which various aspects may be implemented in accordance with one or more aspects described herein.

### DETAILED DESCRIPTION

In the following description of various illustrative embodiments, reference is made to the accompanying drawings, which form a part hereof and are shown by way of illustration of various embodiments in which aspects of the disclosure may be practiced. In some instances, other embodiments may be utilized, and structural and functional modifications may be made without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

By way of introduction, aspects discussed herein relate to data and account security processes for automatically detecting fraudulent or unauthorized user requests to organizational or transactional accounts (e.g., bank accounts, credit card accounts, website memberships, streaming media service accounts, transportation accounts, library accounts, governmental accounts, etc. In large organizations, user access to accounts is typically granted on an individual basis and normally approved through a process of authentication in which one or more users are verified as being authentic and authorized to access the account. Some accounts may have multiple users authorized to access an account (e.g., a multi-user account), and each user may have different privilege levels when accessing the account. The multi-user nature of such accounts increases the complexity of detecting fraud or unauthorized access because, for example, the number of locations the account can be simultaneously accessed from and the number of credentials to verify are increased.

The processes, systems, and methods disclosed herein leverage a combination of the computer interaction of multiple users to access a shared account and multimodal data that is indicative of the behavior of the multiple users to detect fraud in a distributed network environment. More specifically, various aspects disclosed below relate to detecting fraudulent transactions in a multi-user account based on multimodal data that reflects the actions of multiple account users. A system and process may receive transaction requests associated with the multi-user account from multiple users at multiple user-interactive computers. A server may receive the transaction requests from the user-interactive computers. The server may also receive multimodal data, such as audio, video, biometric, and other data that provides information about the actions of at least two of the users. The server analyzes the transaction requests and multimodal data to detect correlations between the user's actions and transaction requests that may indicate an unauthorized or fraudulent transaction.

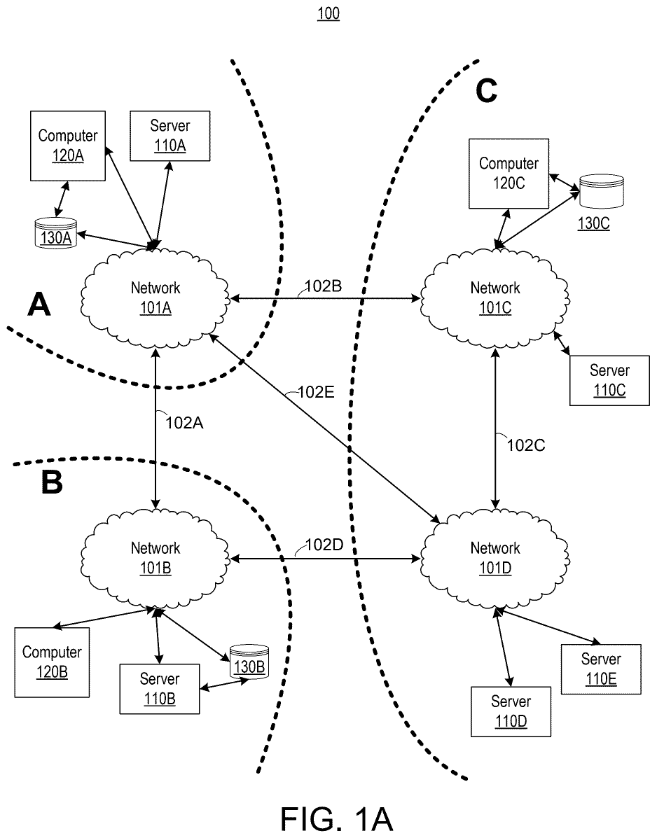

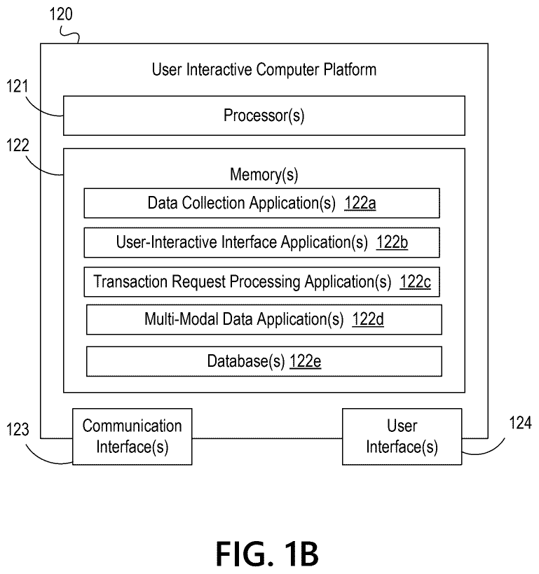

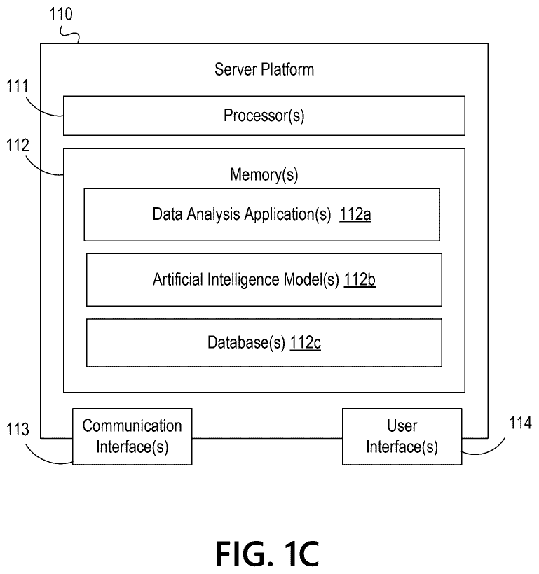

FIGS. 1A-1C depict an illustrative distributed network environment and devices for analyzing transactions in multi-user accounts using multi-modal data. Referring to FIG. 1A, distributed network environment 100 may include multiple networks (e.g., 101A-101D) distributed across multiple regions (e.g., regions A, B, and C) and connected by one or more communication links (e.g., 102A-102E). In some examples, the regions (e.g., regions A, B, and C) may represent different physical locations (e.g., geographic areas, continents, islands, etc.), governmental or administrative territories (e.g., a country, state, US territory), supranational organization (e.g., European Union), divisions within an enterprise (e.g., company divisions), etc.

Distributed network environment 100 may include one or more computing platforms in each region, interconnected by the plurality of networks (e.g., 101A-101D). Each computing platform may include one or more computer servers (e.g., 110A-110E), one or more network memories (e.g., 130A-130C), or one or more computers (e.g., 120A-120C). Each computing platform (e.g., 110A-110E, 120A-120C, 130A-130C) may be connected to the distributed network environment 100 via a communication link to a network (e.g., 101A-101D) within the same region and/or connected by other communication links to different computing platforms within the region. Although a limited number of computer servers, network memory, and computers are shown, any number of systems or devices may be used without departing from the invention.

Each region may have different capabilities, data formats, rules, regulations, or other technical limitations for storing and transferring data and conducting transactions associated with accounts (e.g., bank accounts, streaming service accounts, company employee accounts, etc.). The capabilities, data formats, rules, regulations, or other technical limitations may differ for transactions within a region and from region to region. Each network may have a limited connection to another network (e.g., 101B-101C); thus, transferring data between such networks may require transferring data through one or more intermediate networks (e.g., 101A or 101D).

Networks (e.g., 101B-101D) may include a local area network (LAN), a wide area network (WAN), a wireless telecommunications network, digital subscriber line (DSL) networks, frame relay networks, asynchronous transfer mode (ATM) networks, virtual private networks (VPN), and/or any other communication network or combinations thereof. Networks also include associated “network equipment” such as access points, ethernet adaptors (physical and wireless), firewalls, hubs, modems, routers, and/or switches located inside the network and/or on its periphery, as well as software executing on any of the foregoing. The network connections shown are illustrative, and any means of establishing a communications link between the computers may be used. The existence of any of various network protocols, such as TCP/IP, Ethernet, FTP, HTTP, and the like, and of various wireless communication technologies, such as GSM, CDMA, WiFi, and LTE, is presumed. The various computing platforms described herein may be configured to communicate using any of these network protocols or technologies.

Computers 120A-120C may be configured to provide a user interface through which a user may perform an account transaction. For example, computers 120A-120C may be configured to receive an indication of a request from a user (e.g., card reader initiation of transaction), display one or more user interfaces, provide audio output, receive user input via one or more input devices (e.g., touchscreen, keypad, or the like), receive audio user input, process transactions (e.g., receive deposits, dispense funds, or the like), and the like. Examples of computers 120A-120C may include an Automated Teller Machine (ATM), sales or teller terminal, personal computer or laptop within a residence or business (e.g., connected via Wifi), point-of-sale (POS) system, smartphone connected through a cellular network, or other computing device.

Computer Servers (e.g., 110A-110E) may receive communications from user interface computers (e.g., 120A-120C), for example, that include transaction requests from users, and process those transactions and/or perform other tasks related to transactions, such as detecting fraudulent or unauthorized transactions. The servers may host web services that provide an interface for users to access accounts via user interface computers (e.g., 120A-120C).

The computer servers (e.g., 110A-110E) may further receive multimodal data related to the transactions, users performing transactions, or systems and/or personnel involved in executing transactions. Such multimodal data may include audio data (e.g., from microphones), video or image data (e.g., from cameras), location data (e.g., from GPS), Internet-of-Things (IOT) data, or other data. The multimodal data may be received from a computer (e.g., 120A-120C) from which a transaction request is received or may be received from different computers or devices, such as building security cameras, a personal computing device such as a smartphone, or other devices capable of capturing and transmitting multimodal data to the server. The multimodal data may, for example, indicate the physical actions of users, personnel, or equipment involved in the performance of a transaction related to an account.

Network Memory (e.g., 130A-130C) may include tangible, non-volatile, computer-readable memory that is connected directly to another device, such as a computer (e.g., 120A-120C) or a server (e.g., 110A-110E), or connected and accessible by other devices via a network connection (e.g., via a connection to one of networks 101A-101E). Network memory (e.g., 130A-130C) may store and provide access to one or more databases. Such databases may include but are not limited to relational databases, hierarchical databases, distributed databases, in-memory databases, flat file databases, XML databases, NoSQL databases, graph databases, and/or combinations thereof. The data transferred to and from various computer machines in distributed network environment 100 may include secure and sensitive data, such as account information, confidential documents, and customer personally identifiable information. Data in databases provided in network memory may be stored and transferred in a secure manner using secure network protocols and encryption and/or to protect the integrity of the data when stored on the various computer machines. For example, a file-based or service-based integration scheme may be utilized to transmit data between the various computer machines. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. Databases may be distributed across multiple network memories connected through the distributed network environment. They may utilize tamper-proof data structures, such as blockchains (or other linked lists), sidechains (or different lists of linked lists), or directed acyclic graphs, such as tangles or hash graphs. Tamper-proof encoding may alternatively or additionally use lattice-based cryptography, code-based cryptography, and multivariate cryptography.

Each of the computing platforms (e.g., 110A-110E, 120A-120C, 130A-130C) may be or include one or more computer components (e.g., server blades, memory, processors, or the like) and may each include systems, applications, and the like, for processing data. Accordingly, each of the computing platforms (e.g., 110A-110E, 120A-120C, 130A-130C) may be a plurality of computing devices in a system for processing data and may communicate with each other via machine-to-machine communication or data exchange to process the data.

FIG. 1B illustrates an example user-interactive computing platform 120 that may be used to implement each computer 120A-120C. Computing platform 120 may include one or more processors 121, memory 122, communication interfaces 123, and user interfaces 124 connected via one or more data buses. Communication interface 123 may include a network interface configured to support communication, such as a network 101 or the like. User interface 124 may include a display, speaker, or other device for outputting information to a user and one or more sensor inputs for receiving input from a user. For example, user interface(s) 124 may include a microphone, keypad, touch screen, and/or stylus through which a user of computing device 601 may provide input. It may also include one or more speakers for audio output and a video display device for textual, audiovisual, and/or graphical output. User interface(s) 124 may also include optical scanners (not shown).

Memory 122 may include one or more program modules having instructions that, when executed by processor(s) 121, cause a computing platform 120 to perform one or more functions described herein. Additionally, or alternatively, memory 122 may include one or more databases that may store and/or otherwise maintain information that may be used by such program modules and/or processor(s) 121. In some instances, one or more program modules and/or databases may be stored by and/or maintained in different memory units of computing platform 120 and/or by other computing devices (e.g., network memory 130A-130C) that may form and/or otherwise make up computing platform 120.

For example, memory 122 may have, store, and/or include a data collections application 122a that may store instructions and/or data that may cause or enable the computers (e.g., 120A-120C) to receive user input via a user interface 124, such a request to access an account as further described below. Computing platform 120 may further have, store, and/or include a user-interactive interface application 122b. User-interactive interface application 122b may store instructions and/or data that may cause or enable the computers (e.g., 120A-120C) to operate the user interface 124, such as display a graphical user interface to a user via display or sense input from the user, such as keystrokes on a pin pad or a voice command via a microphone.

Computing platform 120 may further have, store, and/or include transaction request processing application 122c that may process a transaction request (e.g., received by 122a) and transmit the request to one or more servers (e.g., 110A-110C).

Computing platform 120 may further have, store, and/or include multi-modal data application 122d that may receive multimodal data collected or sensed by the computer platform 120 (e.g., with microphones, cameras, IR sensors, fingerprint readers, etc.) and process and/or transmit the multi-modal data to one or more servers as further described below.

Computing platform 120 may further have, store, and/or include database 122e that may store multimodal data and/or transaction request data received or processed by the other applications. Computers 120A-120C may each include some or all of the components included in computing platform 120, as illustrated and described with respect to FIG. 1B. Each network memory (e.g., 130A-130C) may also include all of the components of computing platform 120, though some network memories may not include all applications (e.g., 122a, 122b, 122c, and 122d).

Though not illustrated, computing platform 120 may include other components, such as a cash reception and/or distribution system, card reader, or barcode scanner such that the computing platform 120 may operate as an ATM, point of sale system, or other system for conducting cash or credit transactions.

FIG. 1C illustrates an example server platform 110 that may be used to implement each server 110A-110C. Server platform 110 may include one or more processor(s) 111, memory 112, communication interface 113, and user interface 114, which are the same or similar to the processor(s) 121, memory 121, communication interface 123, and user interface 124, respectively, described above with respect to FIG. 1B. Memory 112 may include one or more program modules having instructions that, when executed by processor(s) 111, cause a server platform 110 to perform one or more functions described herein. Additionally, or alternatively, memory 112 may include one or more databases 112e that may store and/or otherwise maintain information that may be used by such program modules and/or processor(s) 111. In some instances, the one or more program modules and/or databases may be stored by and/or maintained in different memory units of server platform 110 and/or by other server devices (e.g., network memory 110A-110E) that may be connected to, form and/or otherwise make up server platform 110.

For example, memory 112 may have, store, and/or include a data analysis application 112a that may store instructions and/or data that may cause or enable the servers (e.g., 110A-110E) to receive multimodal data and transaction or account access requests via the network (e.g., 101A-101D) from one or more computing platforms (e.g., 120A-120C), and analyze such data to detect fraud or attempted unauthorized access to a multi-user account as further described below.

Server platform 110 may further have, store, and/or include one or more artificial intelligence (AI) models 112b that may be used by data analysis application 112a for detecting fraud and unauthorized account access. The AI model(s) may be trained using previously captured and/or historical transaction data (e.g., user access requests, transaction requests, transaction data) from multi-users with shared access to a multi-user account, as described below. Some examples include additional data, such as multimodal data collected by UI computing platforms 120 or other computing platforms not having a user interface to train the one or more AI models.

Server platform 110 may further have, store, and/or include database(s) 112c, which may store data related to multimodal data, transaction request data, and analysis data generated by the data analysis applications 112a and/or artificial intelligence models 112b. Servers 110A-110E may each include some or all of the components in server platform 110, as illustrated and described with respect to FIG. 1C.

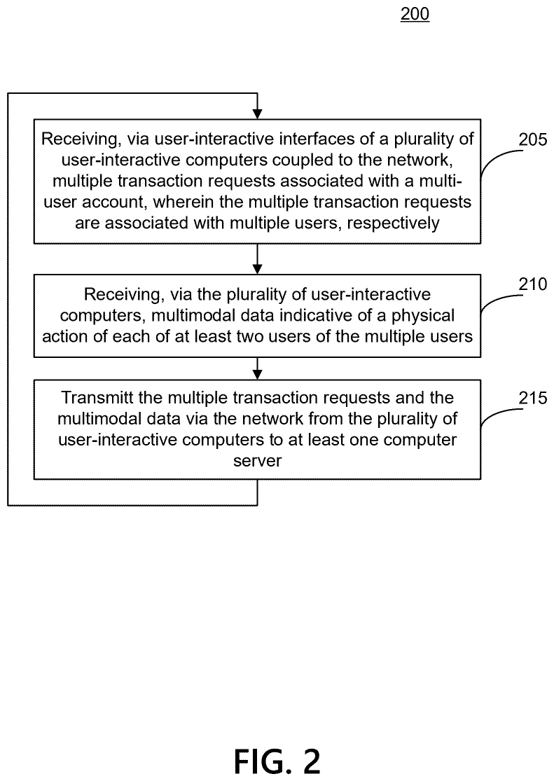

FIG. 2 depicts an illustrative process 200 for receiving transaction requests via user-interactive (UI) computers (e.g., 120A-120C) in accordance with one or more example embodiments. Each UI computer may comprise one or more processors and memory that store applications to perform steps 205-215.

In step 205, a plurality of user-interactive (UI) computers (e.g., 120A-120C) may receive, via user-interactive interfaces, multiple transaction requests associated with a multi-user account. The multiple transaction requests may be associated with multiple users, respectively. For example, the applications, when executed, may cause each of the plurality of user-interactive computers to display a user interface (e.g., graphical user interface) and receive input (e.g., via a touchscreen or buttons), enabling a different user to input information identifying the user, a multi-user account, and credential information for authenticating that the user is authorized to access or transact with the multi-user account. Each UI computer may receive a transaction request to the same multi-user account, but from different users. The transaction requests may be received at the same time or at different times.

In step 210, a plurality of user-interactive (UI) computers (e.g., 120A-120C) may further receive multimodal data indicative of physical action or movement of each of at least two users of the multiple users. For example, each UI computer may include one or more sensors, such as a microphone for sensing sound in the proximity of the UI computer, a camera (e.g., visible or infrared light camera) for capturing an image or video of the area proximate the UI computer, a fingerprint reader for capturing a person's fingerprints, a retina scanner for capturing a person's retina data, LIDAR for capturing motion (e.g., movement of people or cars, or biometric data such as breadth rate), GPS or wireless RF transceiver for capturing a location or motion of the UI computer, or other sensors (e.g., IoT sensors, light sensors) capable of capturing the physical movement or presence of persons in the proximity to the UI computer. In some examples, the sensors are comprised in the user-interactive interfaces such that the multimodal data is received via the user-interactive interfaces. In other examples, the sensors are in proximity to and communicatively coupled to the UI computers. In some examples, the UI computer may modify the user interface to prompt the user to take a particular action, which the multimodal sensors can detect. For example, the user interface may prompt the user to select a specific button in a particular location such that the user turns (e.g., to capture different facial views with a camera) or to detect whether the user is left-handed or right-handed. In other examples, the user interface may prompt the user to respond with a voice command such that the user's voice pattern is detected.

Users may include authorized users of the multi-user account or other persons, such as a person attempting to commit fraud or otherwise conduct an unauthorized transaction with the multi-user account via a UI computer. In some examples, the physical actions or movement of more than one person or user may be sensed at a single UI computer.

In step 215, the plurality of UI computers transmits the multiple transaction requests and the multimodal data via the network (e.g., 101A-101D) from the plurality of user-interactive computers (e.g., 120A-120C) to one or more computer servers (e.g., (110A-110E), where the data may be analyzed as further described below. Steps 205 to 215 may repeat themselves periodically or continuously to receive transaction requests and multimodal data over a period of time and transmit the requests and data as they are received.

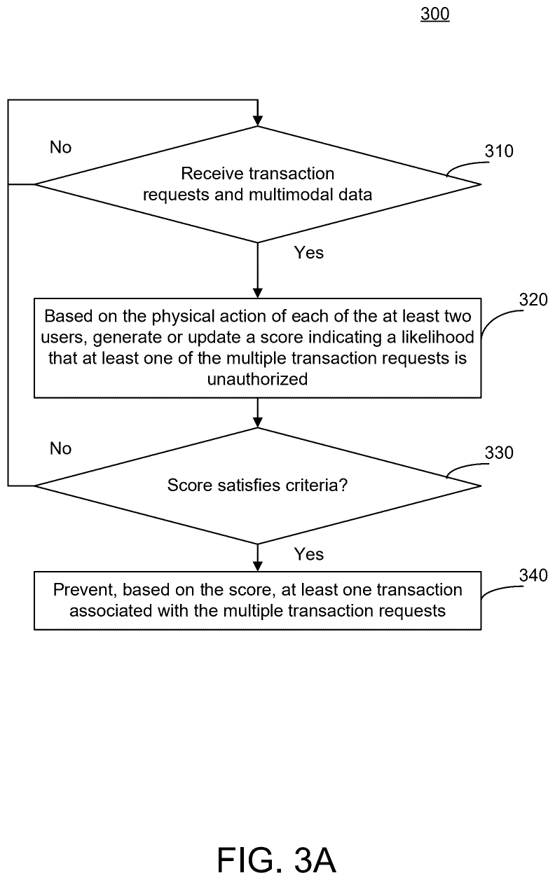

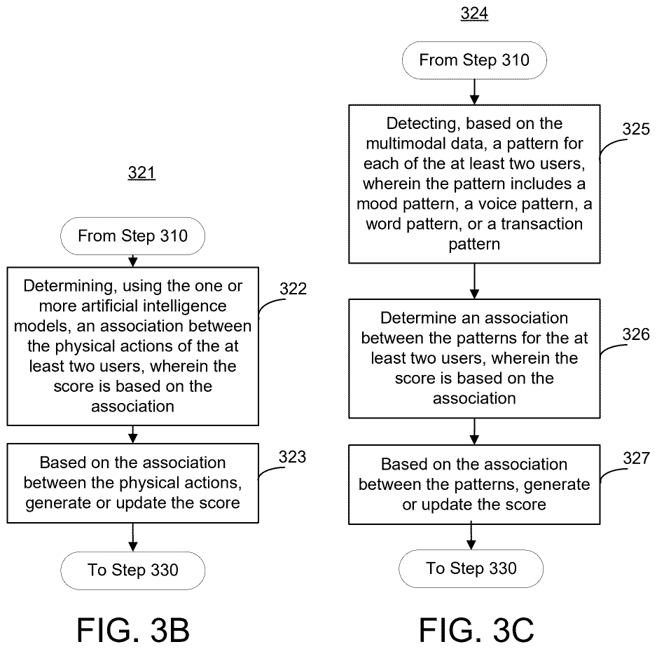

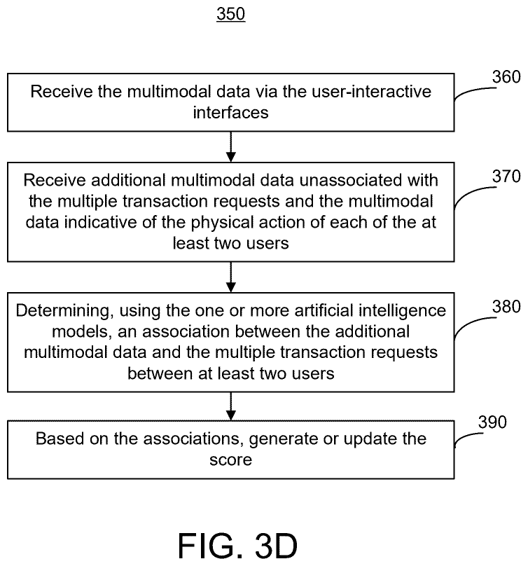

FIG. 3A depicts an illustrative process 300 of one or more computer servers receiving the transaction requests and multimedia data, e.g., from the UI computers, for analyzing the data to detect unauthorized (or attempted unauthorized) transactions with a multi-user account in accordance with one or more example embodiments. Each server may comprise one or more processors and memory that store applications to perform steps 310-340.

In step 310, one or more computer servers receive multiple transaction requests via the network (e.g., 101A-0101D) from the plurality of UI computers (e.g., 120A-120C). In some examples, the computer server also receives multimodal data indicative of the physical action or motion of each of at least two users of the multiple users. The transactions request and multi-modal may be the same or similar to those described above with respect to process 200 in FIG. 2.

In step 320, one or more computer servers may generate a score indicating a likelihood that at least one of the multiple transaction requests is unauthorized. The score may be based on the physical motion or actions of each of at least two users of the UI computers as described above with respect to process 200 in FIG. 2. For example, one or more computer servers may comprise (e.g., in memory) a set of rules or models (e.g., AI models) that receive the transaction requests and multimodal data and analyze the received information to determine actions or motion of at least two of the users of the UI computers. The AI models may detect patterns associated with multiple users' actions that the AI model has been trained to associate with unauthorized transactions or fraudulent activities. Various AI models may be used, including predictive models, deep learning models, large language models, etc., or combinations thereof.

In step 330, one or more computer servers may determine whether the score satisfies criteria indicating at least one transaction request is fraudulent or unauthorized. For example, the score may be a binary value indicating that a transaction is authorized or unauthorized. In other examples, the score may be expressed as a probability (e.g., a percentage), indicating a likelihood that a transaction is unauthorized. In some examples, the score may indicate an abnormal cross-correlation or coordination between multiple users attempting to perform multiple transactions from the same multi-user account. In some examples, the score may be multi-factorial and include a number of indicia, such as indicating an increased stress level of a subset of the multiple users, which might suggest a coordinated effort between multiple users to perform an authorized transaction.

The score may indicate whether a single transaction of a particular user is unauthorized or fraudulent, or may be associated with a plurality of transactions of multiple users and indicate that at least one of the plurality of transactions is unauthorized or fraudulent.

If in step 330, the score is evaluated to determine if it satisfies criteria indicating an unauthorized or fraudulent transaction. In some examples, the criteria may be predetermined static criteria (e.g., greater than a certain percent probability) or dynamic and evaluated by the models, which are continuously or periodically trained to determine what scores correlate to unauthorized transactions.

If in step 330, the score does not satisfy the criteria, the process may return to repeat steps 310 and 320. In repeated step 310, at least one server may continue to receive multiple transaction requests and/or multimodal data over a period of time. In repeated step 320, at least one server may update the score dynamically over the period of time as the multiple transaction requests and the multimodal data are received.

If in step 330 the score satisfies the criteria, the process may proceed to step 340, where the server prevents at least one transaction associated with multiple transaction requests based on the score.

Steps 310-340 may be performed in real or near-real time as transactions are being attempted or performed such that an unauthorized transaction can be prevented before a user completes the transaction at a UI computer. Such examples may include the server using a quantum computing processor to perform at least some of the steps to detect the unauthorized transaction timely. In other examples, at least some of the steps may be performed after the users complete the transactions at the UI computers, and the prevention of the transaction includes after-the-fact reversal of the transaction.

FIG. 3B depicts an illustrative process 321 for performing step 320 of FIG. 3A to generate the score in accordance with one or more example embodiments. In step 322 of process 321, one or more servers may use the AI models to determine an association between the physical actions of at least two users. The AI models may determine cross-correlations or coordination in the motion or actions of the users and detect patterns that the AI model has been trained to associate with unauthorized transactions or fraudulent activities. For example, the AI models may determine and analyze the relative locations of at least two users. In other examples, the AI models may determine and analyze the relative timing of at least two of the multiple transaction requests. In some examples, the multimodal data comprises information associating the physical action of each of at least two users with the multiple transaction requests received via the user-interactive interfaces. For example, the multimodal data (e.g., video from the UI computers) may show (e.g., through facial recognition) one user using multiple different credentials (e.g., of multiple other users) to withdraw money from a multi-user account at multiple different UI computers (e.g., ATMs), respectively. The AI models may detect that the same user is present for each transaction, and generate a score indicating a likelihood of unauthorized or fraudulent transactions. In this example, the AI model need not detect who the user is or whether or not the user is one of the authorized users of the multi-user account. In other examples, the AI models may detect that multiple transactions from multiple users (authorized or unauthorized users) are coordinated in time, location, and/or amount, and determine that the transactions are duplicative or otherwise improper, and thus, generate a score indicating a probability of fraudulent transactions.

In step 323, one or more servers may generate the score based on the cross-correlations, coordination, or associations detected in step 322 between the physical actions of multiple users detected by the AI models.

FIG. 3C depicts another illustrative process 324 for performing step 320 of FIG. 3A in accordance with one or more example embodiments. In step 325 of process 324, one or more servers, using the AI models with the multimodal data as inputs, may detect a pattern for each of at least two users, wherein the pattern may not represent the actions or movement of a user. For example, the pattern could be a mood or stress pattern based on biometric information (e.g., breadth rate, facial expressions, posture) gleaned from the multimodal data. Other examples may include a voice pattern or word pattern (e.g., detected by a microphone), or a transaction pattern (e.g., detected by the server). In step 326, one or more servers using the AI models may determine an association between the detected patterns for at least two users. For example, the AI model may detect an increased stress level of a subset of the multiple users, which might suggest a coordinated effort between multiple users to perform an authorized transaction. The detected association may be between patterns detected in step 325 or between one or more patterns detected in step 325 with movement of physical actions detected in step 322 of process 321.

In step 327, one or more servers may generate the score based on the cross-correlations, coordination, or associations detected in step 326 between the patterns of multiple users detected by the AI models.

In various examples, processes 321 and 322 may be combined. For example, AI models may detect a correlation between one or more patterns detected in step 325 of process 322 and movement or physical action detected in step 322 of process 321, and the score may be generated based on this correlation.

FIG. 3D depicts an illustrative process 350 that may be performed with process 300 of FIG. 3A for detecting unauthorized transactions in a multi-user account based on additional multimodal data in accordance with one or more example embodiments. In step 360 of process 350, one or more servers may receive the multimodal data indicative of the physical action of each of at least two users from the plurality of UI computers (e.g., 120A-120C), for example, as previously described with respect to step 310 of process 300 in FIG. 3A. Such multimodal data may be identified (e.g., by the UI computers) as associated multimodal data because it is captured in coordination with or as part of a transaction being performed at a UI computer. The associated multimodal data may be structured (e.g., include timestamps, an origin identifier, a transaction identifier, etc.) such that the server can match it to a particular transaction request.

In step 370, one or more servers may receive additional multimodal data unassociated with the multiple transaction requests. For example, such multimodal data may include security video footage of a facility, such as a bank or business lobby or parking lot. In other examples, the multimodal data may include a credit report of one of the users, public records about a particular user, new reports, etc. Such multimodal data may be identified (e.g., by the server) as unassociated multimodal data because it is not captured in coordination with and/or is not part of a transaction being performed at a UI computer.

In step 380, one or more servers, using the AI models, may determine an association between the unassociated multimodal data and the multiple transaction requests and/or the associated multimodal data. For example, the AI model may identify an association between a withdrawal of a certain amount of money by one user from the multi-user account and the financing of a new sports car by another user as indicated in the other user's credit report. In a further example, the AI model may detect multiple withdrawals from a multi-user account at different branches of a bank using credentials from multiple different users, respectively, while also detecting through security footage the same user at each of the banks during those transactions. The AI models may infer from such an association of the security footage with the transaction data that the transactions are fraudulent. In another example, the multimodal data may include two-way authentication via an authentication device (e.g., a smart phone), which may be correlated by the servers with other multimodal data, such as video verifying that the authentication device is present and collocated with the users performing a transaction at a UI computer.

In step 390, one or more servers may generate the score based on the determined associations detected in step 380.

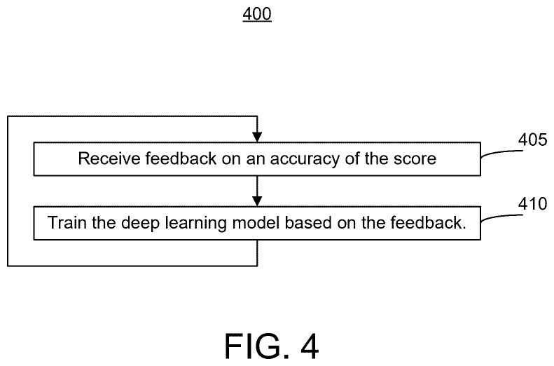

FIG. 4 depicts an illustrative process 400 of training a deep learning model to identify unauthorized transactions in a multi-user account in accordance with one or more example embodiments. In step 405 of process 400, one or more servers may receive feedback on the accuracy of one or more scores that were generated based on the processes of FIGS. 3A-3D. For example, based on the one or more servers generating a score indicating a transaction is unauthorized and causing the transaction to be prevented (e.g., steps 320-340), an after-action report or other information may be generated (e.g., by the one or more servers) based on human evaluation and/or intervention that verifies whether or not the score was accurate (e.g., whether or not the transaction was authorized). In another example, the one or more servers may verify the score based on the user providing additional authentication credentials.

In step 410, the one or more servers may further train the deep learning model based on the feedback. In some examples, the deep learning model is trained in real or near-real time as the transactions from multiple users of a multi-user account are conducted, scores are generated, and feedback s provided (e.g., by providing additional credentials during the transactions). In other examples, the training may be based on historical data or past authorized and unauthorized transactions by multiple users of a multi-user account. The historical data may be acquired by past performances of one or more steps described with respect to FIGS. 3A-3D, or may be acquired by other methods that detected fraudulent transactions, e.g., involving coordinated actions by multiple users. Once trained, the deep learning models may be stored in memory, for example, in one or more servers or in network memory for later use.

The steps of process 400 may operate continuously (e.g., in a recursive loop) to update the deep learning model while any of the methods of FIGS. 3A-3D use the model continuously (e.g., as it is updated) to detect unauthorized transactions.

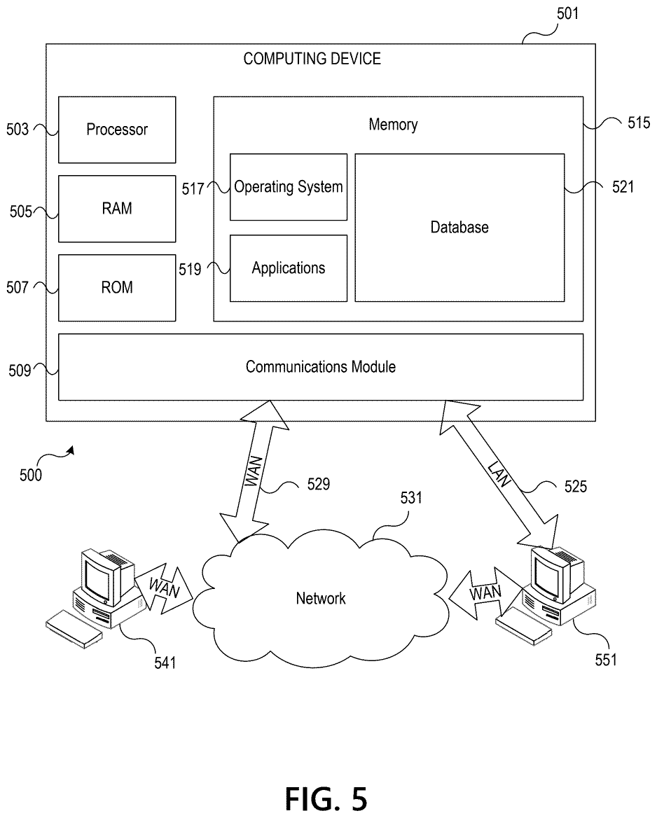

FIG. 5 depicts an illustrative operating environment in which various aspects of the present disclosure may be implemented in accordance with one or more example embodiments. Computing System Environment 500 is only one example of a suitable computing environment. It is not intended to suggest any limitation regarding the scope of use or functionality contained in the disclosure. Computing System Environment 500 should not be interpreted as having any dependency or requirement relating to any one or combination of components shown in illustrative Computing System Environment 500. Computing System Environment 500 elements for implementing any of the computing platforms (e.g., 101A-101D, 102A-102E, 110, 110A-110E, 120, 120A-120C, and/or 130A-130C) in addition or as an alternative to those elements as described above with respect to FIGS. 1A-1C.

Computing system environment 500 may include processor 503 for controlling the overall operation of computing device 501 and its associated components, including Random Access Memory (RAM) 505, Read-Only Memory (ROM) 507, communications module 509, and memory 515. Computing device 501 may include a variety of computer-readable media. Computer-readable media may be any available media that may be accessed by computing device 501, may be non-transitory, and may include volatile and nonvolatile, removable and non-removable media implemented in any method or technology for storage of information such as computer-readable instructions, object code, data structures, program modules, or other data. Examples of computer-readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor (e.g., hardware processor) on computing device 501. Such a processor may execute computer-executable instructions stored on a computer-readable medium.

Software may be stored within memory 515 and/or storage to provide instructions to processor 503 for enabling computing device 501 to perform various functions as discussed herein. For example, memory 515 may store software used by computing device 501, such as operating system 517, application programs 519, and associated database 521. Also, some or all of the computer-executable instructions for computing device 501 may be embodied in hardware or firmware. Although not shown, RAM 505 may include one or more applications representing the application data stored in RAM 505 while computing device 501 is on and corresponding software applications (e.g., software tasks) are running on computing device 501.

Communications module 509 may include a microphone, keypad, touch screen, and/or stylus through which a user of computing device 501 may provide input. It may also include one or more speakers for providing audio output and a video display device for providing textual, audiovisual, and/or graphical output. Computing system environment 500 may also include optical scanners (not shown).

Computing device 501 may operate in a networked environment supporting connections to one or more remote computing devices, such as 541 and 551. Computing devices 541 and 551 may be personal computing devices or servers that include any or all of the elements described above relative to computing device 501.

The network connections depicted in FIG. 5 may include Local Area Network (LAN) 525 and Wide Area Network (WAN) 529, as well as other networks. When used in a LAN networking environment, computing device 501 may be connected to LAN 525 through a network interface or adapter in communications module 509. When used in a WAN networking environment, computing device 501 may include a modem in communications module 509 or other means for establishing communications over WAN 529, such as network 531 (e.g., public network, private network, Internet, intranet, and the like). The network connections shown are illustrative, and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP), and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smartphones, multiprocessor systems, microprocessor-based systems, set-top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, etc. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to implement one or more aspects of the disclosure more effectively, and such data structures are contemplated to be within the scope of computer-executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events described herein may be transferred between a source and a destination in light or electromagnetic waves traveling through signal-conducting media such as metal wires, optical fibers, or wireless transmission media (e.g., air or space). In general, one or more computer-readable media may be and/or include one or more non-transitory computer-readable media.

As described herein, the various methods and acts may be operative across one or more computing servers and one or more networks. The functionality may be distributed in any manner or may be located in a single computing device (e.g., a server, a client computer, and the like). For example, in alternative embodiments, one or more of the computing platforms discussed above may be combined into a single computing platform, and the single computing platform may perform the various functions of each computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

1. A system for analyzing transactions for multi-user accounts on a network, the system comprising:
a plurality of user-interactive computers coupled to the network and comprising first processors and first memory having data collection applications stored therein, wherein the data collection applications, when executed by the first processors, cause the plurality of user-interactive computers to:
receive, via user-interactive interfaces, multiple transaction requests associated with a multi-user account, wherein the multiple transaction requests are associated with multiple users, respectively; and
at least one computer server coupled to the network and comprising at least one second processor and second memory having at least one data analysis application stored therein, wherein the at least one data analysis application, when executed by the at least one second processor, causes the at least one computer server to:
receive the multiple transaction requests via the network from the plurality of user-interactive computers;
receive multimodal sensor data indicative of a physical action of each of at least two users of the multiple users;
generate, using one or more artificial intelligence models and based on the physical action of each of the at least two users, a score indicating a likelihood that at least one of the multiple transaction requests is unauthorized; and
prevent, based on the score, at least one transaction, associated with the multiple transaction requests, from being executed via the plurality of user-interactive computers.

2. The system of claim 1, wherein the at least one data analysis application, when executed by the at least one second processor, causes the at least one computer server to:
determine, using the one or more artificial intelligence models, a correlation between each physical action of the at least two users, wherein the score is based on the correlation.

3. (canceled)

4. (canceled)

5. The system of claim 1, wherein the one or more artificial intelligence models comprise a deep learning model, and wherein the at least one data analysis application, when executed by the at least one second processor, causes the at least one computer server to:
receive feedback on an accuracy of the score; and train the deep learning model based on the feedback.

6. (canceled)

7. The system of claim 1, wherein the score is based on relative locations of the at least two users or relative timing of at least two of the multiple transaction requests.

8. The system of claim 1, wherein the multimodal sensor data comprises information associating the physical action of each of the at least two users with the multiple transaction requests received via the user-interactive interfaces.

9. The system of claim 8, wherein:
the at least one data analysis application, when executed by the at least one second processor, causes the at least one computer server to:
receive the multimodal sensor data indicative of the physical action of each of the at least two users from the plurality of user-interactive computers;
receive additional multimodal sensor data unassociated with the multiple transaction requests; and
determine, using the one or more artificial intelligence models, an association between the additional multimodal sensor data and the multiple transaction requests, wherein the score is based on the association.

10. A method for conducting transactions on a network, the method comprising:
receiving, via user-interactive interfaces of a plurality of user-interactive computers coupled to the network, multiple transaction requests associated with a multi-user account, wherein the multiple transaction requests are associated with multiple users, respectively;
transmitting the multiple transaction requests via the network from the plurality of user-interactive computers to at least one computer server;
receiving, with the at least one computer server, multimodal sensor data indicative of a physical action of each of at least two users of the multiple users;
generating, with the at least one computer server using one or more artificial intelligence models and based on the physical action of each of the at least two users, a score indicating a likelihood that at least one of the multiple transaction requests is unauthorized; and
preventing, based on the score, at least one transaction associated with the multiple transaction requests.

11. The method of claim 10, further comprising:
determining, using the one or more artificial intelligence models, an association between each physical action of the at least two users, wherein the score is based on the association.

12. The method of claim 10, further comprising:
detecting, based on the multimodal sensor data, a pattern for each of the at least two users, wherein the pattern includes a mood pattern, a voice pattern, a word pattern, a transaction pattern, a movement pattern, or a location pattern; and
determining an association between the patterns for the at least two users, wherein the score is based on the association.

13. The method of claim 10, further comprising:
receiving the multiple transaction requests and the multimodal sensor data over a period of time; and
updating the score dynamically over the period of time as the multiple transaction requests and the multimodal sensor data is received by the at least one computer server.

14. The method of claim 10, wherein the one or more artificial intelligence models comprise a deep learning model, and wherein the method further comprises:
receiving feedback on an accuracy of the score; and training the deep learning model based on the feedback.

15. The method of claim 10, wherein the multimodal sensor data comprises audio data, voice data, or image data, and wherein the one or more artificial intelligence models detect, using the multimodal sensor data, that a same user is present at multiple di fer it user-interactive computers using different credentials to perform the multiple transaction quests, respectively.

16. The method of claim 10, wherein the score is based on relative locations of the at least two users or relative timing of at least two of the multiple transaction requests.

17. The method of claim 10, wherein the multimodal sensor data comprises information associating the physical action of each of the at least two users with the multiple transaction requests received via the user-interactive interfaces.

18. The method of claim 17, further comprising:
receiving the multimodal sensor data indicative of the physical action of each of the at least two users from the plurality of user-interactive computers;
receiving additional multimodal sensor data unassociated with the multiple transaction requests; and
determining, using the one or more artificial intelligence models, an association between the additional multimodal sensor data and the multiple transaction requests, wherein the score is based on the association.

19. A computer server for analyzing transactions for multi-user accounts on a network, the computer server comprising at least one processor and memory having at least one data analysis application stored therein, wherein the at least one data analysis application, when executed by the at least one processor, causes the computer server to:
receive multiple transaction requests associated with a multi-user account via the network from a plurality of user-interactive computers, wherein the multiple transaction requests are associated with multiple users, respectively;
receive multimodal sensor data indicative of a physical action of each of at least two users of the multiple users;
generate, using one or more artificial intelligence models and based on the physical action of each of the at least two users, a score indicating a likelihood that at least one of the multiple transaction requests is unauthorized; and
prevent, based on the score, at least one transaction associated with the multiple transaction requests.

20. The computer server of claim 19, wherein the at least one data analysis application, when executed by the at least one processor, causes the computer server to:
determine, using the one or more artificial intelligence models, a correlation between each physical action of the at least two users, wherein the score is based on the correlation.

21. The system of claim 1, wherein the score is multi-factorial and includes a number of indicia indicating an increased stress level of a subset of the multiple users.

22. The system of claim 1, wherein the data collection applications, when executed by the first processors, cause the plurality of user-interactive computers to modify the user-interactive interfaces to prompt each of the at least two users to take a particular action detectable by multimodal sensors of the plurality of user-interactive computers.

23. The system of claim 9, wherein the additional multimodal sensor data comprises two-way authentication data from an authentication device, and wherein the one or more artificial intelligence models correlate the two-way authentication data with video data verifying that the authentication device is present and collocated with a user performing a transaction at one of the plurality of user-interactive computers.
